(19) United States
(12) Patent Application Publication
(10) Pub. No.: US 2003/0097267 A1
(43) Pub. Date: May 22, 2003

(54) Complete optimization of model parameters in parametric speech coders

(75) Inventors: Khosrow Lashkari, Freemont, CA (US); Toshio Miki, Cupertino, CA (US)

Correspondence Address: Brinks Hofer Gilson & Lione, P.O. Box 10395, Chicago, IL, 60610, US

(73) Assignee: DoCoMo Communications Laboratories USA, Inc.

(21) Appl. No.: 10/039,528

(22) Filed: Oct. 26, 2001

(51) Int. Cl. G10L 13/04; G10L 13/02

(52) U.S. Cl. 704/262

(57) ABSTRACT

A gradient search algorithm is provided for speech coding systems. The gradient search algorithm calculates the gradient of a speech synthesis polynomial using the contribution of decomposition coefficients. The contribution of the decomposition coefficients is then recalculated at successive iterations.

### BACKGROUND

The present invention relates generally to speech encoding, and more particularly, to an encoder and a gradient search algorithm.

Speech compression is a well known technology for encoding speech into digital data for transmission to a receiver which then reproduces the speech. The digitally encoded speech data can also be stored in a variety of digital media between encoding and later decoding (i.e., reproduction) of the speech.

Speech synthesis systems differ from other analog and digital encoding systems that directly sample an acoustic sound at high bit rates and transmit the raw sampled data to the receiver. Direct sampling systems usually produce a high quality reproduction of the original acoustic sound and is typically preferred when quality reproduction is especially important. Common examples where direct sampling systems are usually used include music phonographs and cassette tapes (analog) and music compact discs and DVDs (digital). One disadvantage of direct sampling systems, however, is the large bandwidth required for transmission of the data and the large memory required for storage of the data. Thus, for example, in a typical encoding system which transmits raw speech data sampled from an original acoustic sound, a data rate as high as 96,000 bits per second is often required.

In contrast, speech synthesis systems use a mathematical model of human speech production. The fundamental techniques of speech modeling are known in the art and are described in B. S. Atal and Suzanne L. Hanauer, Speech Analysis and Synthesis by Linear Prediction of the Speech Wave, The Journal of the Acoustical Society of America 637-55 (vol. 50 1971). The model of human speech production used in speech synthesis systems is usually referred to as a source-filter model. Generally, this model includes an excitation signal that represents air flow produced by the vocal folds, and a synthesis filter that represents the vocal tract (i.e., the glottis, mouth, tongue, nasal cavities and lips). Therefore, the excitation signal acts as an input signal to the synthesis filter similar to the way the vocal folds produce air flow to the vocal tract. The synthesis filter then alters the excitation signal to represent the way the vocal tract manipulates the air flow from the vocal folds. Thus, the resulting synthesized speech signal becomes an approximate representation of the original speech.

One advantage of speech synthesis systems is that the bandwidth needed to transmit a digitized form of the original speech can be greatly reduced compared to direct sampling systems. Thus, by comparison, whereas direct sampling systems transmit raw acoustic data to describe the original sound, speech synthesis systems transmit only a limited amount of control data needed to recreate the mathematical speech model. As a result, a typical speech synthesis system can reduce the bandwidth needed to transmit speech to about 4,800 bits per second.

One problem with speech synthesis systems however is that the quality of the reproduced speech is sometimes relatively poor compared to direct sampling systems. Most speech synthesis systems provide sufficient quality for the receiver to accurately perceive the content of the original speech. However, in some speech synthesis systems, the reproduced speech is not transparent. That is, while the receiver can understand the words originally spoken, the quality of the speech may be poor or annoying. Thus, a speech synthesis system that provides a more accurate speech production model is desirable.

One solution that has been recognized for improving the quality of speech synthesis systems is described in U.S. patent application Ser. No. 09/800,071 to Lashkari et al., hereby incorporated by reference. Briefly stated, this solution involves minimizing a synthesis error between an original speech sample and a synthesized speech sample. One difficulty that was discovered in that speech synthesis system however is the highly nonlinear nature of the synthesis error, which made the problem mathematically intractable. This difficulty was overcome by solving the problem using the roots of the synthesis filter polynomial instead of the coefficients of the polynomial. Accordingly, a root searching algorithm is described therein for finding the roots of the synthesis filter polynomial.

In parametric speech coders that resolve the synthesis filter polynomial using roots instead of coefficients, the effectiveness and efficiency of the root searching algorithm used has an impact on the quality and performance of the speech coder. One root searching algorithm that may be used in such speech coders is a gradient search algorithm. As those in the art well know, gradient search algorithms use an iterative solution process that calculates a gradient vector for a function and estimates the unknown variables using the calculated gradient vector. However, improved gradient search algorithms are desired for use in parametric speech coders.

### BRIEF SUMMARY

Accordingly, an improved gradient search algorithm is provided. The new, improved algorithm recalculates the gradient vector by taking into account the variations of the decomposition coefficients with respect to the roots. Thus, the gradient search algorithm is especially useful with linear predictive coding speech systems that optimize synthesized speech by searching for roots of a polynomial.

### BRIEF DESCRIPTION OF SEVERAL VIEWS OF THE DRAWINGS

The invention, including its construction and method of operation, is illustrated more or less diagrammatically in the drawings, in which:

FIG. 1 is a block diagram of a speech analysis-by-synthesis system;

FIG. 2A is a flow chart of the proposed speech synthesis system;

FIG. 2B is a flow chart of an alternative speech synthesis system;

FIG. 3 is a flow chart of a gradient search algorithm;

FIG. 4 is a timeline-amplitude chart, comparing an original speech sample to an LPC synthesized speech and an optimally synthesized speech;

FIG. 5 is a chart, showing synthesis error reduction and improvement as a result of the optimization; and

FIG. 6 is a spectral chart, comparing an original speech sample to an LPC synthesized speech and an optimally synthesized speech.

### DESCRIPTION

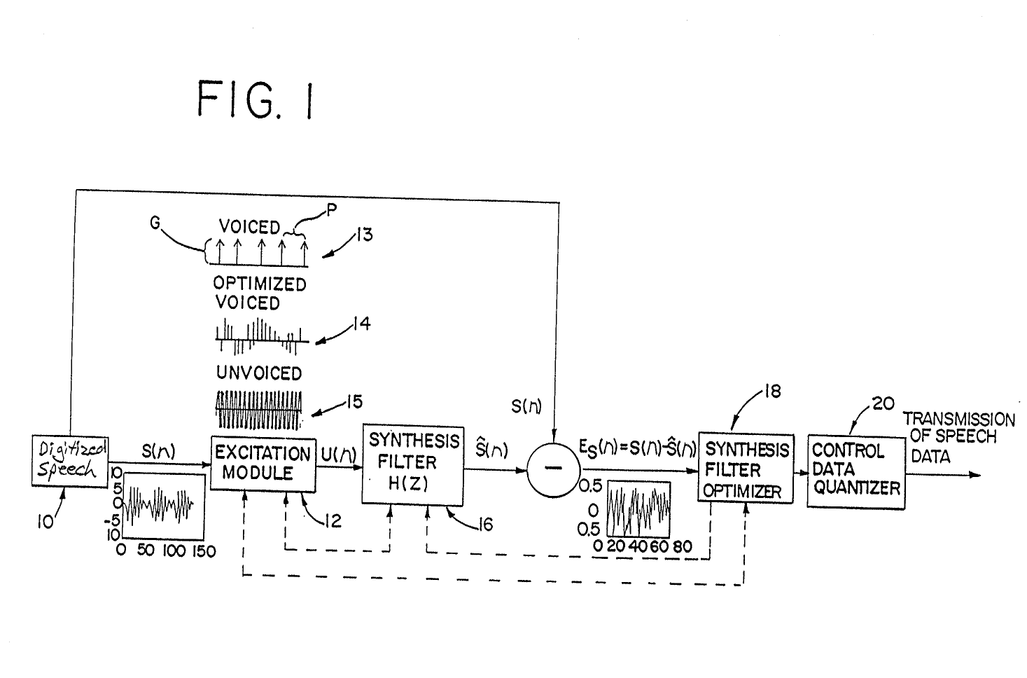

Referring now to the drawings, and particularly to FIG. 1, a speech synthesis system is provided that minimizes the synthesis error in order to more accurately model the original speech. In FIG. 1, a speech analysis-by-synthesis (“AbS”) system is shown which is commonly referred to as a source-filter model. As is well known in the art, source-filter models are designed to mathematically model human speech production. Typically, the model assumes that the human sound-producing mechanisms that produce speech remain fixed, or unchanged, during successive short time intervals (e.g., 20 to 30 ms). The model further assumes that the human sound producing mechanisms can change between successive intervals. The physical mechanisms modeled by this system include air pressure variations generated by the vocal folds, glottis, mouth, tongue, nasal cavities and lips. Therefore, by limiting the digitally encoded data to a small set of control data for each interval, the speech decoder can reproduce the model and recreate the original speech. Thus, raw sampled data of the original speech is not transmitted from the encoder to the decoder. As a result, the digitally encoded data which is transmitted or stored (i.e., the bandwidth, or the number of bits) is much less than required by typical direct sampling systems.

Accordingly, FIG. 1 shows an original digitized speech 10 delivered to an excitation module 12. The excitation module 12 then analyzes each sample s(n) of the original speech and generates an excitation function u(n). The excitation function u(n) is typically a series of pulse signals that represent air bursts from the lungs which are released by the vocal folds to the vocal tract. Depending on the nature of the original speech sample s(n), the excitation function u(n) may be either a voiced 13, 14 or an unvoiced signal 15.

One way to improve the quality of reproduced speech in speech synthesis systems involves improving the accuracy of the voiced excitation function u(n). Traditionally, the excitation function u(n) has been treated as a series of pulses 13 with a fixed magnitude G and period P between the pitch pulses. As those in the art well know, the magnitude G and period P may vary between successive intervals. In contrast to the traditional fixed magnitude M and period P, it has previously been shown to the art that speech synthesis can be improved by optimizing the excitation function u(n) by varying the magnitude and pitch period of the excitation pulses 14. This improvement is described in Bishnu S. Atal and Joel R. Remde, A New Model of LPC Excitation For Producing Natural-Sounding Speech At Low Bit Rates, IEEE International Conference On Acoustics, Speech, And Signal Processing 614-17 (1982). This optimization technique usually requires more intensive computing to encode the original speech s(n), but this problem has not been a significant disadvantage since modern computers provide sufficient computing power for optimization 14 of the excitation function u(n). A greater problem with this improvement has been the additional bandwidth that is required to transmit data for the variable excitation pulses 14. One solution to this problem is a coding system that is described in Manfred R. Schroeder and Bishnu S. Atal, Code-Excited Linear Prediction (CELP): High-Quality Speech At Very Low Bit Rates, IEEE International Conference On Acoustics, Speech, And Signal Processing 937-40 (1985). This solution involves categorizing a number of optimized excitation functions into a library of functions, or a codebook. The encoding excitation module 12 will then select an optimized excitation function from the codebook that produces a synthesized speech that most closely matches the original speech s(n). Then, a code that identifies the optimum codebook entry is transmitted to the decoder. When the decoder receives the transmitted code, the decoder then accesses a corresponding codebook to reproduce the selected optimal excitation function u(n).

The excitation module 12 can also generate an unvoiced 15 excitation function u(n). An unvoiced 15 excitation function u(n) is used when the speaker's vocal folds are open and turbulent air flow is produced through the vocal tract. Most excitation modules 12 model this state by generating an excitation function u(n) consisting of white noise 15 (i.e., a random signal) instead of pulses.

Next, the synthesis filter 16 models the vocal tract and its effect on the air flow from the vocal folds. Typically, the synthesis filter 16 uses a polynomial equation to represent the various shapes of the vocal tract. This technique can be visualized by imagining a multiple section hollow tube with a number of different diameters along the length of the tube. Accordingly, the synthesis filter 16 alters the characteristics of the excitation function u(n) similar to the way the vocal tract alters the air flow from the vocal folds, or in other words, like a variable diameter hollow tube alters inflowing air.

According to Atal and Remde, supra., the synthesis filter 16 can be represented by the mathematical formula:

H(z)=G/A(z) (1)

where G is a gain term representing the loudness of the voice. A(z) is a polynomial of order M and can be represented by the formula:

$$A ( z ) = 1 + {{\sum }^{M}}_{k = 1} {a}_{k} {z}^{- k} \qquad ( 2 )$$

The order of the polynomial A(z) can vary depending on the particular application, but a 10th order polynomial is commonly used with an 8 kHz sampling rate. The relationship of the synthesized speech (n) to the excitation function u(n) as determined by the synthesis filter 16 can be defined by the formula:

$$\hat{s} ( n ) = Gu ( n ) - {{\sum }^{M}}_{k = 1} {a}_{k} \hat{s} ( n - k ) \qquad ( 3 )$$

Conventionally, the coefficients a₁ . . . a_{M} of this polynomial are computed using a technique known in the art as linear predictive coding (“LPC”). LPC-based techniques compute the polynomial coefficients a₁ . . . a_{M} by minimizing the total prediction error Eₚ. Accordingly, the sample prediction error eₚ(n) is defined by the formula:

$${e}_{p} ( n ) = s ( n ) + {{\sum }^{M}}_{k = 1} {a}_{k} s ( n - k ) \qquad ( 4 )$$

The total prediction error Eₚ is then defined by the formula:

$${E}_{p} = {{\sum }^{N - 1}}_{n = 0} {e}_{p}^{2} ( n ) \qquad ( 5 )$$

where N is the length of the analysis window in number of samples. The polynomial coefficients a₁ . . . a_{M} can now be computed by minimizing the total prediction error Eₚ using well known mathematical techniques.

One problem with the LPC technique of computing the polynomial coefficients a₁ . . . a_{M} is that only the prediction error is minimized. Thus, the LPC technique does not minimize the error between the original speech s(n) and the synthesized speech (n). Accordingly, the sample synthesis error eₛ(n) can be defined by the formula:

eₛ(n)=s(n)−ŝ(n) (6)

The total synthesis error Eₛ can then be defined by the formula:

$${E}_{s} = {{\sum }^{N - 1}}_{n = 0} {e}_{s}^{2} ( n ) = {{\sum }^{N - 1}}_{n = 0} {( s ( n ) - \hat{s} ( n ) )}^{2} \qquad ( 7 )$$

where N is the length of the analysis window. Like the total prediction error Eₚ discussed above, the total synthesis error Eₛ should be minimized to compute the optimum filter coefficients a₁ . . . a_{M}. However, one difficulty with this technique is that the synthesized speech (n) as represented in formula (3) makes the total synthesis error Eₛ a highly nonlinear function that is generally mathematically intractable.

One solution to this mathematical difficulty is to minimize the total synthesis error Eₛ using the roots of the polynomial A(z) instead of the coefficients a₁ . . . a_{M}. Using roots instead of coefficients for optimization also provides control over the stability of the synthesis filter 16. Accordingly, assuming that h(n) is the impulse response of the synthesis filter 16, the synthesized speech (n) is now defined by the formula:

$$\hat{s} ( n ) = h ( n ) * u ( n ) = {{\sum }^{n}}_{k = 0} h ( k ) u ( n - k ) \qquad ( 8 )$$

where * is the convolution operator. In this formula, it is also assumed that the excitation function u(n) is zero outside of the interval 0 to N−1. Using the roots of A(z), the polynomial can now be expressed by the formula:

A(z)=(1−λz⁻¹) . . . (1−λ_{M}z⁻¹) (9)

where λ₁ . . . λ_{M} represents the roots of the polynomial A(z). These roots may be either real or complex. Thus, in the preferred 10th order polynomial, A(z) will have 10 different roots.

Using parallel decomposition, the synthesis filter function H(z) is now represented in terms of the roots by the formula:

$$H ( z ) = 1 / A ( z ) = {{\sum }^{M}}_{i = 1} {b}_{i} / ( 1 - {λ}_{1} {z}^{- 1} ) \qquad ( 10 )$$

(the gain term G is omitted from this and the remaining formulas for simplicity). The decomposition coefficients bᵢ are then calculated by the residue method for polynomials, thus providing the formula:

$${b}_{i} = {{\prod }^{M}}_{j = 1 , J \neq i} [ 1 / ( 1 - {λ}_{j} {λ}_{i}^{- 1} ) ] \qquad ( 11 )$$

The impulse response h(n) can also be represented in terms of the roots by the formula:

$$h ( n ) = {{\sum }^{M}}_{i = 1} {{b}_{i} ( {λ}_{i} )}^{n} \qquad ( 12 )$$

Next, by combining formula (12) with formula (8), the synthesized speech (n) can be expressed by the formula:

$$\hat{s} ( n ) = {{\sum }^{n}}_{k = 0} h ( k ) u ( n - k ) = {{\sum }^{n}}_{k = 0} u ( n - k ) {{\sum }^{M}}_{i = 1} {{b}_{i} ( {λ}_{i} )}^{k} \qquad ( 13 )$$

Therefore, by substituting formula (13) into formula (7), the total synthesis error Eₛ can be minimized using polynomial roots and a gradient search algorithm.

A number of root searching algorithms may be used to minimize the total synthesis error Eₛ. One possible algorithm, however, is an iterative gradient search algorithm. Accordingly, denoting the root vector at the j-th iteration as Λ^{(j)}, the root vector can be expressed by the formula:

Λ^{(j)}=[λ₁^{(j)} . . . λᵢ^{(j)} . . . λ_{M}^{(j)}]^{T} (14)

where λᵢ^{(j)} is the value of the i-th root at the j-th iteration and T is the transpose operator. The search algorithm begins with the LPC solution as the starting point, which is expressed by the formula:

Λ⁽⁰⁾=[λ₁⁽⁰⁾ . . . λᵢ⁽⁰⁾ . . . λ_{M}⁽⁰⁾]^{T} (15)

To compute Λ⁽⁰⁾, the LPC coefficients a₁ . . . a_{M} are converted to the corresponding roots λ₁⁽⁰⁾ . . . λ_{M}⁽⁰⁾ using a standard root finding algorithm.

Next, the roots at subsequent iterations can be expressed by the formula:

Λ^{(j+1)}=Λ^{(j)}+μ∇ⱼEₛ (16)

where μ is the step size and ∇ⱼEₛ is the gradient of the synthesis error Eₛ relative to the roots at iteraton j. The step size μ can be either fixed for each iteration, or alternatively, it can be variable and adapted for each iteration. Using formula (7), the synthesis error gradient vector ∇ⱼEₛ can now be calculated by the formula:

$${∇}_{j} {E}_{s} = {{\sum }^{N - 1}}_{k = 0} ( s ( k ) - \hat{s} ( k ) ) {∇}_{j} \hat{s} ( k ) \qquad ( 17 )$$

Formula (17) demonstrates that the synthesis error gradient vector ∇ⱼEₛ can be calculated using the gradient vector of the synthesized speech samples (k). Accordingly, the synthesized speech gradient vector ∇ⱼ(k) can be defined by the formula:

∇ⱼŝ(k)=[∂ŝ(k)/∂λ₁^{(j)} . . . ∂ŝ(k)/∂λᵣ^{(j)} . . . ∂ŝ(k)/∂λ_{M}^{(j)}] (18)

where ∂ŝ(k)/∂λᵣ^{(j)} is the partial derivative of (k) at iteration j with respect to the r-th root. Using formula (13), the partial derivative ∂ŝ(k)/∂λᵣ^{(j)} can be calculated by the formula:

$$\partial \hat{s} ( k ) / \partial {λ}_{r} = {{\sum }^{k}}_{m = 0} {{\sum }^{M}}_{i = 1} u ( k - m ) \partial [ {b}_{i} {λ}_{i}^{m} ] / \partial {λ}_{r} \qquad ( 19 )$$

(the superscript j is omitted from formula (19) through formula (28) for notational simplicity). Formula (19) can now be expressed using the chain rule of differentiation by the formula:

[bᵢλᵢ^{m}]/λᵣ=λᵢ^{m}bᵢ/λᵣ+mbᵢλᵣ^{(m-1)}δ(r−i) (20)

where δ(r−i) is the delta function (i.e., δ(r−i)=1 for r=i and δ(r−i)=0 for r i).

To resolve formula (20), the partial derivative ∂bi/∂λᵣ must be calculated. Therefore, formula (11) can be substituted into the partial derivative ∂bi/∂λᵣ to provide the formula:

$${b}_{i} / {λ}_{r} = \{ {\prod }_{j = 1 , j \neq i}^{M} [ 1 / ( 1 - {λ}_{j} {λ}_{i}^{- 1} ) ] \} / {λ}_{r} \qquad ( 21 )$$

To resolve the partial derivative of formula (21), the partial derivative must be calculated for two cases, including r i and r=i.

In the first case of formula (20), where r i, only one multiplicative term of 1/(1−λᵣλᵢ⁻¹), which corresponds to j=r, depends on λᵣ. Therefore, the partial derivative of formula (21) can be expressed by the formula:

$$\{ {\prod }_{j = 1 , j \neq i}^{M} [ 1 / ( 1 - {λ}_{j} {λ}_{i}^{- 1} ) ] \} / {λ}_{r} = \{ {\prod }_{j = 1 , j \neq i}^{M} [ 1 / ( 1 - {λ}_{j} {λ}_{i}^{- 1} ) ] \} [ 1 / ( 1 - {λ}_{r} {λ}_{i}^{- 1} ) ] / {λ}_{r} ( r i ) \qquad ( \text{22a} )$$

Next, the partial derivative of 1/(1−λᵣλᵢ⁻¹) can be calculated by the formula:

[1/(1−λᵣλᵢ⁻¹)]/λᵣ=λᵢ/(λᵢ−λᵣ)² (22b)

By substituting formula (22b) into formula (22a) and simplifying, formula (22a) can be expressed by the formula:

$$\{ {\prod }_{j = 1 , j \neq i}^{M} [ 1 / ( 1 - {λ}_{j} {λ}_{i}^{- 1} ) ] \} / {λ}_{r} = {b}_{i} / ( {λ}_{i} - {λ}_{r} ) ( ri ) \qquad ( \text{22c} )$$

By substituting formula (22c) into formula (21) and further simplifying, the partial derivative of ∂bᵢ/∂λᵣ for the case of r i can now be expressed by the formula:

bⱼ/λᵣ=(bᵢ/λᵢ)[1/(1−λᵣλᵢ⁻¹)] (r i) (22d)

In the second case of formula (21) where r=i, all of the M−1 multiplicative terms of 1/(1−λⱼλᵢ⁻¹) depend on λᵢ. Therefore, the partial derivative of formula (21) can be calculated as the sum of the M−1 contributions to the partial derivative. Thus, using the q-th multiplicative term (i.e., 1(1−λ_{q}λᵢ⁻¹)), the contribution to the partial derivative due to this term alone can be expressed by the formula:

$$\{ {\prod }_{j = 1 , j \neq i}^{M} [ 1 / ( 1 - {λ}_{j} {λ}_{i}^{- 1} ) ] \} [ 1 / ( 1 - {λ}_{q} {λ}_{i}^{- 1} ) ] / {λ}_{i} ( r = i ) \qquad ( \text{23a} )$$

Next, the partial derivative of 1/(1−λ_{q}λᵢ⁻¹) can be calculated by the formula:

[1/(1−λ_{q}λᵢ⁻¹)]/λⱼ=−λ_{q}/(λᵢ−λ_{q})² (23b)

By substituting formula (23b) into formula (23a) and simplifying, formula (23a) can be expressed by the formula:

$$\{ {\prod }_{j = 1 , j \neq i}^{M} [ 1 / ( 1 - {λ}_{j} {λ}_{i}^{- 1} ) ] \} [ 1 / ( 1 - {λ}_{q} {λ}_{i}^{- 1} ) ] / {λ}_{i} = {b}_{i} / {λ}_{i} ( 1 - {λ}_{i} {λ}_{q}^{- 1} ) \qquad ( \text{23c} )$$

Using formula (23c) to add up all of the contributions in formula (23a) and then substituting the result into formula (21) and further simplifying, the partial derivative of ∂bᵢ/∂λᵣ for the case of r=i can now be expressed by the formula:

$${b}_{i} / {λ}_{r} = ( {b}_{i} / {λ}_{i} ) {\prod }_{j = 1 , j \neq i}^{j = M} [ 1 / ( 1 - {λ}_{i} {λ}_{j}^{- 1} ) ] ( r = i ) \qquad ( \text{23d} )$$

In order to unify the two cases of r i and r=i, the function K(i,r) can be defined by the following formulas:

K(i,r)=1/(1−λᵣλᵢ⁻¹) (if r i) (24a)

$$K ( i , r ) = {\prod }_{j = 1 , j \neq i}^{M} [ 1 / ( 1 - {λ}_{i} {λ}_{j}^{- 1} ) ] ( if r = i ) \qquad ( \text{24b} )$$

The partial derivative of ∂bᵢ/∂λᵣ can now be simplified for both cases by the formula:

bᵢ/λᵣ=bᵢK(i,r)/λᵢ (for any r) (25)

By substituting formula (25) into formula (20), the partial derivative of [bᵢλᵢ^{m}]/λᵣ can now be expressed by the formula:

[bᵢλᵢ^{m}]/λᵣ=bᵢ[K(i,r)λᵢ^{(m-1)}+mλᵣ^{(m-1)}δ(r−i)] (26)

In formula (26), the first term of the formula (i.e., K(i,r)λᵢ^{(m-1)}) is the contribution of bᵢ/λᵢ, while the second term of the formula (i.e., mλᵣ^{(m-1)}δ(r−i)) is the contribution of the m-th power of λᵢ.

By substituting formula (26) into formula (19), the partial derivative of the k-th sample of the synthesized speech with respect to the r-th root can be expressed by the formula:

$$( k ) / {λ}_{r} = {{\sum }^{k}}_{m = 0} u ( k - m ) {{\sum }^{i = M}}_{i = 1} {b}_{i} [ K ( i , r ) {λ}_{i}^{( m - 1 )} + m {λ}_{r}^{( m - 1 )} δ ( r - i ) ] \qquad ( 27 )$$

By simplifying formula (27), the partial derivative can be expressed by the formula:

$$( k ) / {λ}_{r} = {\sum }_{m = 0}^{k} u ( k - m ) {\sum }_{i = 1}^{1 = M} {b}_{i} K ( i , r ) {λ}_{i}^{( m - 1 )} + {b}_{r} {\sum }_{m = 1}^{k} mu ( k - m ) {λ}_{r}^{( m - 1 )} \qquad ( 28 )$$

For completeness, the iteration index j can be inserted back into formula (28) to express the partial derivative of the synthesized speech at iteration j by the formula:

$$( k ) / {λ}_{r}^{( j )} = {\sum }_{m = 0}^{k} u ( k - m ) {\sum }_{i = 1}^{i = m} {b}_{i} K ( i , r ) {( {λ}_{i}^{( j )} )}^{m - 1} + {b}_{r} {\sum }_{m = 1}^{k} mu ( k - m ) {( {λ}_{r}^{( j )} )}^{( m - 1 )} ( k 0 ) \qquad ( 29 )$$

The synthesis error gradient vector ∇ⱼEₛ is now calculated by substituting formula (29) into formula (18) and formula (18) into formula (17). The subsequent root vector Λ^{(j+1)} at the next iteration can then be calculated by substituting the result of formula (17) into formula (16). The iterations of the gradient search algorithm are then repeated until either the synthesis error Eₛ is reduced by a desired percentage from the LPC prediction error Eₚ, a predetermined number of iterations are completed, or the roots are resolved within a predetermined acceptable range.

Although control data for the optimal synthesis polynomial A(z) can be transmitted in a number of different formats, it is preferable to convert the roots found by the optimization technique described above back into polynomial coefficients a₁ . . . a_{M}. The conversion can be performed by well known mathematical techniques. This conversion allows the optimized synthesis polynomial A(z) to be transmitted in the same format as existing speech coders, thus promoting compatibility with current standards.

Now that the synthesis model has been completely determined, the control data for the model is quantized into digital data for transmission or storage. Many different industry standards exist for quantization. However, in one example, the control data that is quantized includes ten synthesis filter coefficients a₁ , . . . a₁₀, one gain value G for the magnitude of the excitation function pulses, one pitch period value P for the frequency of the excitation function pulses, and one indicator for a voiced 13 or unvoiced 15 excitation function u(n). As is apparent, this example does not include an optimized excitation pulse 14, which could be included with some additional control data. Accordingly, the described example requires the transmission of thirteen distinct variables at the end of each speech frame. Commonly, the thirteen variables are quantized into a total of 80 bits. Thus, according to this example, the synthesized speech (n), including optimization, can be transmitted within a bandwidth of 4,000 bits/s (80 bits/frame÷0.020 s/frame).

As shown in FIG. 1, the order of operations can be changed depending on the accuracy desired and the computing capacity available. Thus, in the embodiment described above, the excitation function u(n) was first determined to be a preset series of pulses 13 for voiced speech or an unvoiced signal 15. Second, the synthesis filter polynomial A(z) was determined using conventional techniques, such as the LPC method. Third, the synthesis polynomial A(z) was optimized.

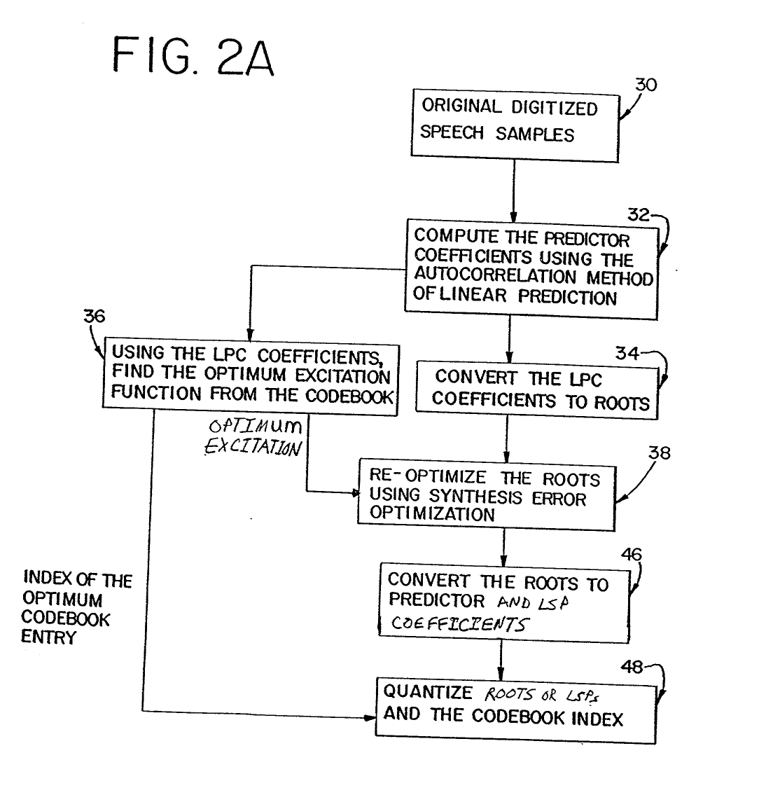

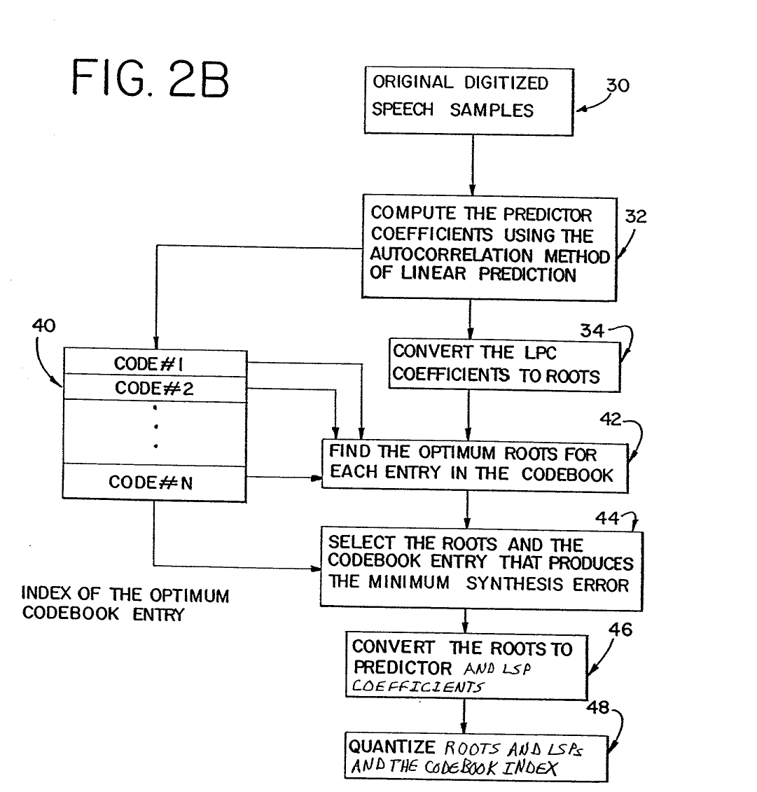

In FIGS. 2A and 2B, different encoding sequences are shown which should provide more accurate synthesis and may be used with CELP-type speech encoders. However, some additional computing power will typically be required. In these sequences, the original digitized speech sample 30 is used to compute 32 the polynomial coefficients a₁ . . . a_{M} using the LPC technique described above or another comparable method. The polynomial coefficients a₁ . . . a_{M}, are then used to find 36 the optimum excitation function u(n) from a codebook. Alternatively, an individual excitation function u(n) can be found 40 from the codebook for each iteration. After selection of the excitation function u(n), the polynomial coefficients a₁ . . . a_{M} are then also optimized. To make optimization of the coefficients a₁ . . . a_{M} easier, the polynomial coefficients a₁ . . . a_{M} are first converted 34 to the roots of the polynomial A(z). A gradient search algorithm is then used to optimize 38, 42, 44 the roots. Once the optimal roots are found, the roots are then converted 46 back to polynomial coefficients a₁ . . . a_{M} for compatibility with existing encoding-decoding systems. Lastly, the synthesis model and the index to the codebook entry is quantized 48 for transmission or storage.

Additional encoding sequences are also possible for improving the accuracy of the synthesis model or for changing the computing capacity needed to encode the synthesis model. Some of these alternative sequences are demonstrated in FIG. 1 by dashed routing lines. For example, the excitation function u(n) can be reoptimized at various stages during encoding of the synthesis model.

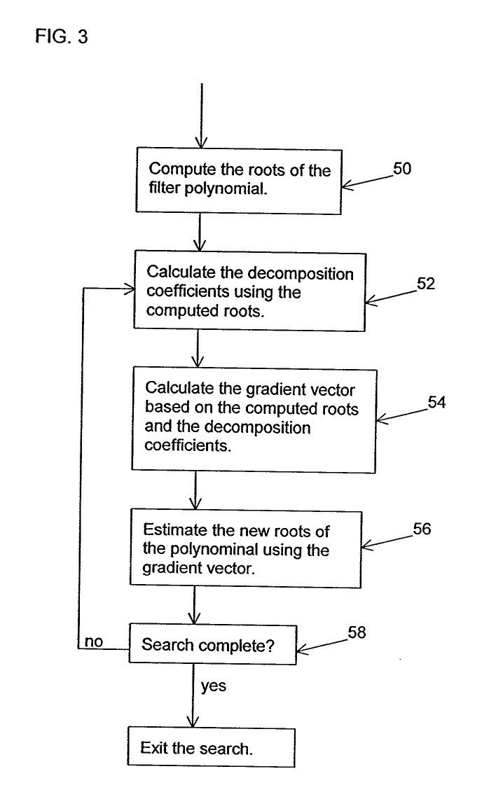

In FIG. 3, a flow chart of the gradient search algorithm is shown. After the polynominal coefficients a₁ . . . a_{M} have been converted to roots 34, first roots of the polynominal are computed 50. The initial roots may be determined by several methods, including root finding algorithms such as Newton-Raphson or interval halving. Decomposition coefficients bᵢ are then calculated using the first computed roots 52. Next, the gradient vector of the polynominal is calculated using the contribution of the decomposition coefficients bᵢ 54. Once the gradient vector is calculated for the first computed roots, the gradient vector is used to calculate second estimated roots 56. A test is then performed to determine whether the search should end or whether it should continue 58. Several tests may be used, including testing whether the LPC prediction error Eₚ has been reduced by a desired percentage, whether a limited number of iterations has been completed, or whether the estimated roots are within an acceptable range. If the search is determined to be complete, the gradient search algorithm stops and the estimated roots are passed on to the speech synthesis system for further processing 58. On the other hand, if the search is not determined to be complete, the decomposition coefficients bᵢ are recalculated using the second estimated roots 52. The process of calculating the gradient vector and re-estimating the roots is then repeated using the new contribution of the recalculated decomposition coefficients be 54, 56.

The improvement of the gradient search algorithm is now apparent. In gradient search algorithms used in other speech synthesis systems, such as the system described in U.S. patent application Ser. No. 09/800,071 to Lashkari et al., the decomposition coefficients are assumed to be constant during successive iterations of the gradient search. While this assumption provides acceptable results for some applications, improved results are achieved by the gradient search algorithm because variations in the decomposition coefficients that occur during successive iterations are considered when calculating the gradient vector.

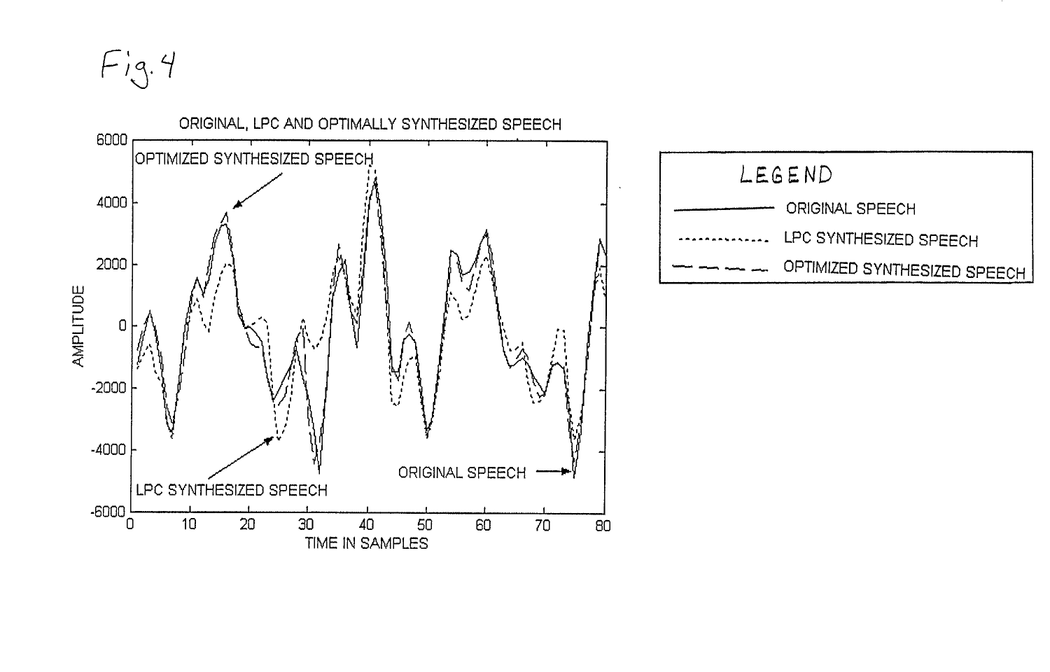

FIGS. 4-6, show the improved results provided by the optimized speech synthesis system. The figures show several different comparisons between a prior art LPC synthesis system and the optimized synthesis system. The speech sample used for this comparison is a segment of a voiced part of the nasal “m”. In FIG. 4, a timeline-amplitude chart of the original speech, a prior art LPC synthesized speech and the optimized synthesized speech is shown. As can be seen, the optimally synthesized speech matches the original speech much closer than the LPC synthesized speech.

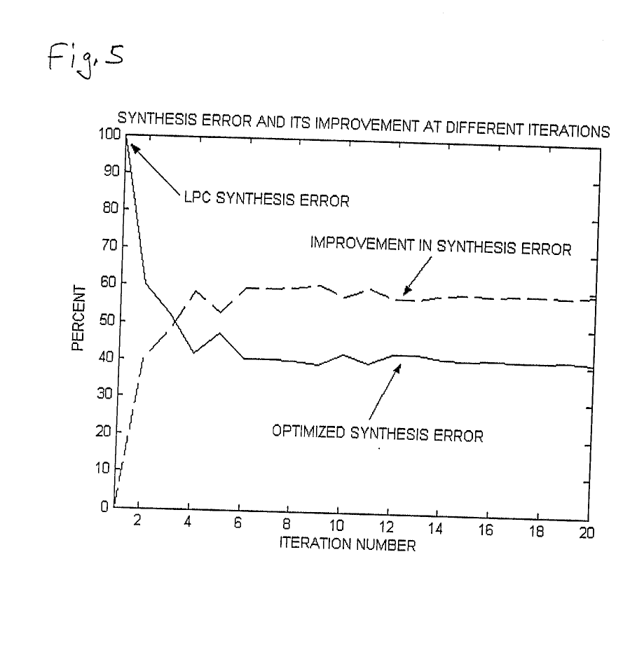

In FIG. 5, the reduction in the synthesis error is shown for successive iterations of optimization. At the first iteration, the synthesis error equals the LPC synthesis error since the LPC coefficients serve as the starting point for the optimization. Thus, the improvement in the synthesis error is zero at the first iteration. Accordingly, the synthesis error steadily decreases with each iteration. Noticeably, the synthesis error increases (and the improvement decreases) at iteration number three. This characteristic occurs when the root searching algorithm overshoots the optimal roots. After overshooting the optimal roots, the search algorithm can be expected to take the overshoot into account in successive iterations, thereby resulting in further reductions in the synthesis error. In the example shown, the synthesis error can be seen to be reduced by 59% after six iterations. Thus, a significant improvement over the LPC synthesis error is possible with the optimization.

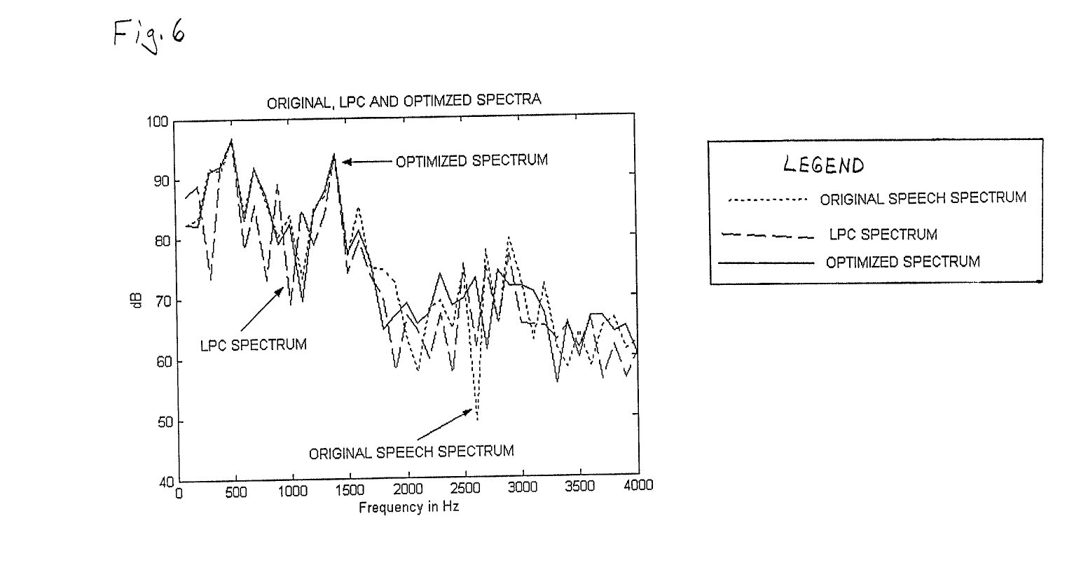

FIG. 6 shows a spectral chart of the original speech, the LPC synthesized speech and the optimized synthesized speech. As seen in this chart, the spectrum of the optimized speech provides a much better match to the spectrum of the original speech as compared to the LPC spectrum. The improvement in the synthesized spectrum is especially apparent in the frequency range of 0 to 1,500 Hz.

While preferred embodiments of the invention have been described, it should be understood that the invention is not so limited, and modifications may be made without departing from the invention. The scope of the invention is defined by the appended claims, and all devices that come within the meaning of the claims, either literally or by equivalence, are intended to be embraced therein.

We claim:

1. A gradient search algorithm for a speech coding system, comprising calculating a gradient vector; and calculating a contribution to said gradient vector in response to variations in decomposition coefficients.

2. The gradient search algorithm according to claim 1, used in combination with finding roots of a speech synthesis polynomial, wherein said gradient search algorithm further comprises iteratively calculating said gradient vector and recalculating said contribution at each iteration, whereby said decomposition coefficients vary between iterations.

3. The gradient search algorithm according to claim 2, wherein one of said decomposition coefficients corresponds to each of a plurality of said roots.

4. The gradient search algorithm according to claim 3, wherein said gradient vector and said contribution to said gradient vector are calculated using the formula:
$$( k ) / {λ}_{r}^{( j )} = {\sum }_{m = 0}^{k} u ( k - m ) {\sum }_{i = 1}^{i = m} {b}_{i} K ( i , r ) {( {λ}_{i}^{( j )} )}^{( m - 1 )} + {b}_{r} {\sum }_{m = 1}^{k} mu ( k - m ) {( {λ}_{r}^{( j )} )}^{( m - 1 )} ( k 0 ) .$$

5. The gradient search algorithm according to claim 1, used in combination with a speech coding system for encoding original speech, the speech coding system comprising an excitation module responsive to an original speech sample and generating an excitation function; a synthesis filter responsive to said excitation function and said original speech sample and generating a synthesized speech sample; and a synthesis filter optimizer responsive to said excitation function and said synthesis filter and generating an optimized synthesized speech sample; wherein said synthesis filter optimizer minimizes a synthesis error between said original speech sample and said synthesized speech sample; wherein the gradient search algorithm is used by said synthesis filter optimizer.

6. The gradient search algorithm according to claim 5, wherein said synthesis filter optimizer comprises a root optimization algorithm, thereby making possible said minimization of said synthesis error; wherein said synthesis filter comprises a predictive coding technique producing said synthesized speech sample from said original speech sample; wherein said predictive coding technique produces first coefficients of a polynomial; wherein said root optimization algorithm is an iterative algorithm using first roots derived from said first coefficients in a first iteration; and wherein said root optimization algorithm produces second roots using the gradient search algorithm in successive iterations resulting in a reduction of said synthesis error in said successive iterations.

7. The gradient search algorithm according to claim 6, wherein the gradient search algorithm further comprises iteratively calculating said gradient vector and recalculating said contribution at each iteration, whereby said decomposition coefficients vary between iterations, and wherein one of said decomposition coefficients corresponds to each of a plurality of said roots.

8. The gradient search algorithm according to claim 7, wherein said gradient vector and said contribution to said gradient vector are calculated using the formula:
$$( k ) / {λ}_{r}^{( j )} = {\sum }_{m = 0}^{k} u ( k - m ) {\sum }_{i = 1}^{i = m} {b}_{i} K ( i , r ) {( {λ}_{i}^{( j )} )}^{( m - 1 )} + {b}_{r} {\sum }_{m = 1}^{K} mu ( k - m ) {( {λ}_{r}^{( j )} )}^{( m - 1 )} ( k 0 ) .$$

9. A gradient search algorithm for a speech coding system, comprising calculating decomposition coefficients; calculating a first gradient of a polynomial using said decomposition coefficients; estimating roots of said polynomial using said first gradient; recalculating said decomposition coefficients based on said estimating; calculating a second gradient of said polynomial using said recalculated decomposition coefficients; and estimating said roots of said polynomial using said second gradient.

10. The gradient search algorithm according to claim 9, wherein said gradient and said decomposition coefficients are calculated using the formulas:
$$\begin{matrix}( k ) / {λ}_{r}^{( j )} = {\sum }_{m = 0}^{k} u ( k - m ) {\sum }_{i = 1}^{i = m} {b}_{i} K ( i , r ) {( {λ}_{i}^{( j )} )}^{( m - 1 )} + \\ {b}_{r} {\sum }_{m = 1}^{k} mu ( k - m ) {( {λ}_{r}^{( j )} )}^{( m - 1 )} ( k 0 ) \\ {b}_{i} = {\prod }_{j = 1 , j \neq i}^{m} [ 1 / ( 1 - {λ}_{j} {λ}_{i}^{- 1} ) ] .\end{matrix}$$

11. The gradient search algorithm according to claim 9, used in combination with a linear predictive coding speech system.

12. The gradient search algorithm according to claim 9, used in combination with a method of generating a speech synthesis filter representative of a vocal tract, the method comprising computing a first synthesis error between an original speech and a first synthesized speech sample corresponding to roots estimated with said first gradient; and computing a second synthesis error between said original speech and a second synthesized speech corresponding to roots estimated with said second gradient; wherein said second synthesis error is less than said first synthesis error.

13. The gradient search algorithm according to claim 12, wherein said gradient and said decomposition coefficients are calculated using the formulas:
$$\begin{matrix}( k ) / {λ}_{r}^{( j )} = {\sum }_{m = 0}^{k} u ( k - m ) {\sum }_{i = 1}^{i = m} {b}_{i} K ( i , r ) {( {λ}_{i}^{( j )} )}^{( m - 1 )} + \\ {b}_{r} {\sum }_{m = 1}^{k} mu ( k - m ) {( {λ}_{r}^{( j )} )}^{( m - 1 )} ( k 0 ) \\ {b}_{i} = {\prod }_{j = 1 , j \neq i}^{m} [ 1 / ( 1 - {λ}_{j} {λ}_{i}^{- 1} ) ] .\end{matrix}$$

14. A gradient search algorithm for a speech coding system, comprising means for calculating decomposition coefficients of a speech synthesis polynomial; means for calculating first roots of said polynomial using said decomposition coefficients; means for recalculating said decomposition coefficients based on said first roots; and means for calculating second roots of said polynomial using said recalculated decomposition coefficients.
